(19) United States
(12) Patent Application Publication
(10) Pub. No.: US 2011/0045265 A1
(43) Pub. Date: Feb. 24, 2011

(54) Polyolefin composition and film thereof

(76) Inventors: Jeffrey C. Haley, Cincinnati, OH (US); Harilaos Mavridis, Lebanon, OH (US); Dennis M. Hudson, Chicago, IL (US); Ganesh Nagarajan, Farmington Hills, MI (US); Stephen M. Imfeld, Mason, OH (US); Giampaolo Pellegatti, Ferrara (IT)

Correspondence Address: LyondellBasell Industries, 3801 WEST CHESTER PIKE, NEWTOWN SQUARE, PA, 19073, US

(21) Appl. No.: 12/583,547

(22) Filed: Aug. 20, 2009

(51) Int. Cl. C08L 23/04; B32B 27/32

(52) U.S. Cl. 428/220; 525/240

(57) ABSTRACT

A polyolefin composition is disclosed. The composition comprises a single-site linear low density polyethylene (mLLDPE) and an elastoplastic polypropylene. The elastoplastic polypropylene is present in an amount sufficient to improve the processability and physical property of the mLLDPE. The composition preferably comprises from 70 wt % to 99 wt % of mLLDPE and from 1 wt % to 30 wt % of the elastoplastic polypropylene. The polyolefin composition of the invention exhibits improved bubble stability in the blown film extrusion compared to the mLLDPE and improved film properties such as tear strength and modulus compared to the traditional blend of mLLDPE and low density polyethylene.

### FIELD OF THE INVENTION

The invention relates to a polyolefin composition. More particularly, the invention relates to a polyolefin composition which comprises a single-site linear low density polyethylene (mLLDPE) and an elastoplastic polypropylene.

### BACKGROUND OF THE INVENTION

One of the main uses of polyethylene is in film applications such as grocery bags, trash can liners, shipping sacks, food and non-food packaging, wide width films for agricultural, construction, industrial and container lining, collation/unitization shrink films, stretch hood films, pond liners and geomembranes. The key physical parameters of polyethylene film include tear strength, impact strength, tensile strength, stiffness and optical properties. Critical processing properties on the film line include the output, bubble stability, gauge control (variability in film thickness), extruder pressure and temperature.

There are two types of linear low density polyethylene in the industry: LLDPE made by Ziegler catalysts and mLLDPE made by single-site catalysts. Single-site catalysts include metallocene single-site catalysts (which contain Cp ligands) and non-metallocene single-site catalysts (which contain non-Cp ligands). Compared to LLDPE, mLLDPE has improved film mechanical properties such as impact resistance and tensile properties. However, mLLDPE has poor bubble stability in the film blowing process, especially for thicker film (2.0 mils or greater). This problem ultimately limits the maximum output rate of film extrusion. To improve bubble stability, mLLDPE is often blended with low density polyethylene (LDPE) made by free radical polymerization. Although the blend has improved processability, it has reduced film properties such as tear strength and impact resistance.

The industry needs new mLLDPE compositions. Ideally, the mLLDPE composition will not only have improved processability but also retain the film properties of mLLDPE.

### SUMMARY OF THE INVENTION

The invention is a polyolefin composition. The composition comprises a single-site linear low density polyethylene (mLLDPE) and an elastoplastic polypropylene. The elastoplastic polypropylene is present in an amount sufficient to improve the processability and physical properties of the mLLDPE. Preferably, the composition comprises from 70 wt % to 99 wt % of mLLDPE and from 1 wt % to 30 wt % of the elastoplastic polypropylene. By “mLLDPE,” we mean any linear low density polyethylene made by single-site catalysts including metallocene single-site catalysts and non-metallocene single-site catalyst. By “elastoplastic polypropylene,” we mean any polypropylene which has properties between thermoplastic and elastomeric polypropylenes. Suitable elastoplastic polypropylene has a density preferably from 0.850 g/cm³ to 0.890 g/cm³, and more preferably from 0.855 g/cm³ to 0.885 g/cm³. It preferably displays no or relatively low degree of crystallinity, indicatively from 0 to 35% measured by X-ray. It preferably has a hardness (Shore D, ISO 868) less than or equal to 90 points, more preferably less than or equal to 70 points, and most preferably less than or equal to 40 points. It preferably has a melting point, measured by differential scanning calorimetry (DSC) at a heating/cooling rate of 10-20° C./min, of 142° C. or less, and more preferably of 90° C. or less. It preferably has a heat of fusion, measured with DSC under the above said conditions, of 75 J/g or less. It preferably has a molecular weight distribution, Mw/Mn, measured by gel permeation chromatography in trichlorobenzene at 135° C., from 1.5 to 15, more preferably from 1.5 to 10, and most preferably from 2.5 to 10. It preferably has a melt flow rate (MFR, measured at 230° C., 2.16 kg) from 0.1 dg/min to 3 dg/min, and more preferably from 0.5 dg/min to 2.5 dg/min. It preferably has a flexural modulus (ISO 178A) less than 200 MPa, more preferably from 50 to 170, and most preferably from 75 to 125. It preferably has a tensile strength at break from 2 MPa to 50 MPa, and more preferably from 5 MPa to 20 MPa. It preferably has a tensile elongation at break from 450% to 900%, and more preferably from 600% to 800%. The elastoplastic polypropylene preferably comprises a polypropylene and a polyolefin elastomer. The polypropylene is preferably a propylene homopolymer or a propylene copolymer with an olefin comonomer which comprises at least 85 wt % of propylene. The polyolefin elastomer is preferably selected from the group consisting ethylene-propylene based rubbers, ethylene-butene based rubbers, the like, and mixtures thereof. The polyolefin composition of the invention exhibits improved bubble stability in the blown film extrusion compared to the mLLDPE and improved film properties such as impact strength, tear strength and modulus compared with the traditional blend of mLLDPE and LDPE (low density polyethylene).

### DETAILED DESCRIPTION OF THE INVENTION

The composition of the invention comprises an mLLDPE and an elastoplastic polypropylene. The elastoplastic polypropylene is present in an amount sufficient to improve the processability and physical properties of the mLLDPE. Preferably, the composition comprises from 70 wt % to 95 wt % of mLLDPE and from 5 wt % to 30 wt % of elastoplastic polypropylene. More preferably, the composition comprises from 85 wt % to 95 wt % of mLLDPE and from 5 wt % to 15 wt % of elastoplastic polypropylene.

Many mLLDPE resins are commercially available. Examples include Starflex® mLLDPE from LyondellBasell Industries and Exceed® mLLDPE from ExxonMobil Chemical. Metallocene single-site catalysts are transition metal compounds that contain cyclopentadienyl (Cp) or Cp derivative ligands. For example, U.S. Pat. No. 4,542,199, the teachings of which are incorporated herein by reference, teaches metallocene catalysts. Non-metallocene single-site catalysts contain ligands other than Cp but have the same catalytic characteristics as metallocenes. For example, U.S. Pat. No. 6,034,027 teaches non-metallocene catalysts.

The mLLDPE preferably has a density within the range of 0.880 g/cm³ to 0.944 g/cm³, more preferably within the range of 0.910 g/cm³ to 0.930 g/cm³, and most preferably within the range of 0.920 g/cm³ to 0.930 g/cm³. The mLLDPE has an MI₂ preferably within the range of 0.05 to 50 dg/min, more preferably within the range of 0.1 dg/min to 10 dg/min, and most preferably within the range of 0.5 dg/min to 5 dg/min. The MI₂ is measured according to ASTM D-1238 at 190° C. under 2.16 kg pressure. Preferably the mLLDPE has a molecular weight distribution Mw/Mn less than 7, more preferably less than 5, and most preferably less than 3. The mLLDPE typical is a copolymer of ethylene with 5 wt % to 15 wt % of one or more C₃—C₁₀ α-olefins. Suitable α-olefins include propylene, 1-butene, 1-pentene, 1-hexene, 4-methyl-1-pentene, and 1-octene, the like, and mixtures thereof. Preferably, the α-olefin is selected from the group consisting of 1-butene, 1-hexene, 1-octene, and mixtures thereof.

Suitable elastoplastic polypropylene has a density preferably from 0.850 g/cm³ to 0.890 g/cm³, and more preferably from 0.855 g/cm³ to 0.885 g/cm³. It preferably displays no or relatively low degree of crystallinity, indicatively from 0 to 35% measured by X-ray. It preferably has a hardness (Shore D, ISO 868) less than or equal to 90 points, more preferably less than or equal to 70 points, and most preferably less than or equal to 40 points. It preferably has a melting point, measured by differential scanning calorimetry (DSC) at a heating/cooling rate of 10-20° C., of 142° C. or less, and more preferably of 90° C. or less. It preferably has a heat of fusion, measured with DSC under the above said conditions, of 75 J/g or less. It preferably has a molecular weight distribution, Mw/Mn, measured by gel permeation chromatography in trichlorobenzene at 135° C., from 1.5 to 15, more preferably from 1.5 to 10, and most preferably from 2.5 to 10. It preferably has a melt flow rate (MFR, measured at 230° C., 2.16 kg) from 0.1 dg/min to 3 dg/min, and more preferably from 0.5 dg/min to 2.5 dg/min. It preferably has a flexural modulus (ISO 178A) less than 200 MPa, more preferably from 50 to 170, and most preferably from 75 to 125. It preferably has a tensile strength at break from 2 MPa to 50 MPa, and more preferably from 5 MPa to 20 MPa. It preferably has a tensile elongation at break from 450% to 900%, and more preferably from 600% to 800%.

Suitable elastoplastic polypropylene preferably comprises a polypropylene component and a polyolefin elastomer component. The polypropylene component can be a propylene homopolymer or a propylene random copolymer with ethylene or C₄—C₈ α-olefins. Suitable C₄—C₈ α-olefins include 1-butene, 1-pentene, 1-hexene, 4-methyl-1-pentene, and 1-octene, the like, and mixtures thereof. Preferably, the propylene random copolymer comprises at least 80 wt % of propylene. More preferably, the propylene random copolymer comprises at least 90 wt % of propylene. Preferably, the polypropylene has an isotactic index greater than 80, more preferably greater than 85, and most preferably greater than 90.

The polyolefin elastomer of the elastoplastic polypropylene is preferably selected from the group consisting of ethylene-propylene based rubbers, ethylene-1-butene based rubbers, the like, and mixtures thereof. The ethylene-propylene based rubber preferably comprises from 35 wt % to 85 w t% of ethylene and from 15 wt % to 65 wt % of propylene, and more preferably from 18 wt % to 40 wt % of ethylene and from 60 wt % to 82 wt % of propylene. The ethylene-propylene based rubber can optionally comprise other comonomers. Other suitable comonomers include 1-butene, 1-pentene, 1-hexene, 4-methyl-1-pentene, 1-octene, butadiene, isoprene, the like, and mixtures thereof. Suitable ethylene-1-butene based rubber preferably comprises from 60 wt % to 90 wt % of ethylene and from 10 wt % to 40 wt % of 1-butene, and more preferably from 70 wt % to 85 wt % of ethylene and from 15 wt % to 30 wt % of 1-butene. The ethylene-1-butene based rubber can optionally comprise other comonomers. Other suitable comonomers include propylene, 1-pentene, 1-hexene, 4-methyl-1-pentene, 1-octene, butadiene, isoprene, the like, and mixtures thereof.

Preferably, the elastoplastic polypropylene comprises from 10 wt % to 70 wt % of the polypropylene and from 30 wt % to 90 wt % of the polyolefin elastomer. More preferably, the elastoplastic polypropylene comprises from 20 wt % to 45 wt % of the polypropylene and from 55 wt % to 80 wt % of the polyolefin elastomer.

The elastoplastic polypropylene is preferably made by a multistage process. The polypropylene can be made in a first stage and the polyolefin elastomer then be made in a second stage in the presence of the polypropylene. The polypropylene exists as a matrix and the polyolefin elastomer is dispersed therein. Methods for making elastoplastic polypropylene are known. For instance, U.S. Pat. No. 5,300,365, the teachings of which are incorporated herein by reference, disclose a multistage process for making elastoplastic polypropylene. A particularly preferred elastoplastic polypropylene comprises (a) from 10 wt % to 50 wt % of a homopolymer of propylene with isotactic index greater than 80, or a copolymer of propylene and a comonomer selected from the group consisting of ethylene, C₄—C₈ α-olefins, and mixtures thereof, which comprises greater than 85 wt % of propylene and has an isotactic index greater than 80; (b) from 5 wt % to 20 wt % of a copolymer of ethylene and one or more C₃—C₈ α-olefins, which comprises greater than 51 wt % of ethylene and is preferably insoluble in xylene at ambient temperature; and (c) from 40 wt % to 80 wt % of a copolymer of ethylene and one or more C₃—C₈ α-olefins, which preferably comprises from 20 wt % to 40 wt % of ethylene, is preferably soluble in xylene at ambient temperature, and preferably has an intrinsic viscosity from 1.5 to 5.5 dl/g; wherein the sum of (b) and (c) is preferably from 50 wt % to 90 wt % of the total elastoplastic polypropylene and the (b)/(c) weight ratio is less than 0.4.

Suitable elastoplastic polypropylene also includes the so-called plastomers. Plastomers are generally produced by single-site catalysts. Suitable plastomers include propylene copolymers containing up to 40 wt % of an olefin comonomer. Preferably, the plastomer comprises from 0.1 wt % to 40 wt %, more preferably from 0.1 wt % to 25 wt % of olefin comonomers selected from the group consisting of ethylene, C₄—C₈ α-olefin, and mixtures thereof. Ethylene is a particularly preferred comonomer.

Many elastoplastic polypropylenes are commercially available and suitable for use in the invention. Examples include Adflex® and Softell® resins from LyondellBasell Industries, Versify® elastomers and plastomers from Dow Chemical, Vistamaxx® elastomers from ExxonMobil Chemical, the like, and mixtures thereof.

Optionally, the polyolefin composition of the invention comprises a third polymer. Adding a third polymer into the composition can either enhance the performance of the product or reduce the cost. For example, addition of a third polymer may increase the printability or the clarity of the film. Suitable third polymers include polyethylene resins other than those specified above, e.g., low density polyethylene (LDPE) and HDPE, polyester, acrylic resin, polyvinyl alcohol, polyvinyl chloride, polyvinyl acetate, polyvinyl ether, ethylene-vinyl acetate copolymers (EVA), ethylene-vinyl alcohol copolymers (EVOH), ethylene-acrylic acid copolymers, the like, and mixtures thereof. A third polymer is added in an amount preferably less than 25 wt % of the total composition. Optionally, the polyolefin composition also comprises antioxidants, UV-absorbents, flow agents, or other additives. The additives are well known in the art. For example, U.S. Pat. Nos. 4,086,204, 4,331,586 and 4,812,500, the teachings of which are herein incorporated by reference, teach UV stabilizers for polyolefins. Additives are added in an amount preferably less than 10 wt % of the total composition.

The mLLDPE and the elastoplastic polypropylene are mixed by any suitable mixing technique. The polymers and optional additives can be blended in solution or in thermal processing. Melt screw extrusion is preferred. Alternatively, the composition of the invention can be made by in situ polymerization. For instance, the mLLDPE can be prepared and the elastoplastic polypropylene can then be prepared in the presence of the mLLDPE. For another instance, the elastoplastic polypropylene can be prepared first and the mLLDPE can then be prepared in the presence of the elastoplastic polypropylene.

The invention includes films made from the polyolefin composition. By the term “film” shall include sheets which are typically thicker than films. Preferably, the film has a thickness greater than 1 mil. More preferably, the film has a thickness within the range of 1 to 20 mils, more preferably 2 to 10 mils, and most preferably 3 mils to 10 mils. One advantage of the invention is that a thick film or sheet can be produced due to the improved bubble stability of the polyolefin composition. Another advantage of the invention is that the film exhibits a combination of high MD tear strength, high dart drop impact strength, and high modulus compared to conventional blends of mLLDPE and LDPE. The film has a 1% secant machine-direction (MD) modulus preferably greater than or equal to 30000 psi, more preferably greater than or equal to 35000 psi, and most preferably greater than or equal to 40000 psi; it has an MD tear strength preferably greater than or equal to 300 grams, more preferably greater than or equal to 700 grams, and most preferably greater than or equal to 1000 grams; it has a dart drop impact strength preferably greater than 750 grams, more preferably greater than or equal to 1000 grams, and most preferably greater than or equal to 1900 grams.

The following examples merely illustrate the invention. Those skilled in the art will recognize many variations that are within the spirit of the invention and scope of the claims.

### EXAMPLES

Starflex GM1810 is a metallocene linear low density polyethylene (mLLDPE) from LyondellBasell Industries with a melt index MI₂ of 1 dg/min and a density of 0.918 g/cm³. Exceed 1023 is an mLLDPE from ExxonMobil Chemical with a melt index of 1 dg/min and a density of 0.923 g/cm³. NA940000 is a tubular LDPE grade from LyondellBasell Industries with a melt index of 0.25 dg/min and a density of 0.918 g/cm³. EPP1 is an elastoplastic polypropylene prepared according to the general procedure disclosed in U.S. Pat. No. 5,300,365. EPP1 has a melt flow rate of 0.6 dg/min (230° C./2.16kg), density of 0.89 g/cm³, flexural modulus (ISO 178/A) of 80 MPa, and a Shore D hardness (ISO 868) of 32 points, and comprises:

A. 32 wt % of a crystalline propylene random copolymer containing 3.5 wt % of ethylene and about 6% of a fraction soluble in xylene at 25° C., and having an intrinsic viscosity [η] of 1.5 dl/g;

B. 7.5 wt % of an essentially linear ethylene/propylene copolymer totally insoluble in xylene at 25° C.; and

C. 60.5 wt % of an ethylene/propylene copolymer containing 25 wt % of ethylene, totally soluble in xylene at 25° C., and having an intrinsic viscosity [η] of 3.2 dl/g.

Blends as shown in Table 1 are made by mixing the components in a rotating drum to form salt-and-pepper pellet blends at room temperature (23° C.). Films are prepared from the blends on a blown film line. The film die is 6 in. in diameter with a 0.060 in. die gap. Films are processed in conventional blown film extrusion with a 2.5:1 blow up ratio, a nominal frost line height of 41 in., and an output rate of 150 lbs/hour. Films with thicknesses of 1 mil and 3 mils, respectively, are prepared.

Machine direction Elmendorf tear strength measurements are conducted following the methods of ASTM D1922. Dart drop impact strength is measured following the ASTM D1709 method for stretched film dart drop at 26 in. The machine direction film modulus is measured following the ASTM E111 method for the 1% Secant modulus.

Viscosity measurements are performed as follows. Sections of films are cut and compression-molded into disks 25 mm in diameter and approximately 1 mm in thickness. Dynamic rheology measurements are conducted at 190° C. in the linear viscoelastic regime. From these results, the amplitude of the complex viscosity is extracted at the frequency where the amplitude of the shear stress is 2 kPa.

The test results are listed in Table 1. The results indicate that the composition of the invention (Ex. 4, 5, 9 and 10) have improved melt viscosity compared to the mLLDPE resins (C. Ex. 1 and 6). The results also indicate that the composition of the invention not only have comparable or improved melt viscosity (indication of bubble stability) to those traditional blends of mLLDPE and LDPE (C.

Ex. 2, 3, 7 and 8) but also retain high MD tear, MD modulus, and dart drop impact strength of the mLLDPE films.

TABLE 1
MELT VISCOSITIES AND FILM PROPERTIES OF THE COMPOSITIONS
OF THE INVENTION AND COMPARATIVE COMPOSITIONS

| | Materials | | | | 1-mil Film Properties | | | 3-mil Film Properties | | |
|---|---|---|---|---|---|---|---|---|---|---|
| | | Elasto- | | Melt | MD | | | MD | | |
| Example | | plastic | | Viscosity | Modulus | MD | | Modulus | MD | Dart Drop |
| Number | mLLDPE | PP | LDPE | k. poise | psi | Tear g | Dart Drop F50 g | psi | Tear g | F50 g |
| C. Ex. 1 | 100 parts | — | — | 72 | 29100 | 288 | 1120 | 32700 | 1174 | >1950 |
| | GM1810 | | | | | | | | | |
| C. Ex. 2 | 90 parts | — | 10 parts | 90 | 32600 | 173 | 209 | 32900 | 799 | 1070 |
| | GM1810 | | NA940000 | | | | | | | |
| C. Ex. 3 | 80 parts | — | 20 parts | 103 | 36200 | 106 | 169 | 31600 | 794 | 690 |
| | GM1810 | | NA940000 | | | | | | | |
| Ex. 4 | 90 parts | 10 parts | — | 87 | 29100 | 252 | 1250 | 31200 | 968 | >1950 |
| | GM1810 | EPP1 | | | | | | | | |
| Ex. 5 | 80 parts | 20 parts | — | 109 | 26300 | 182 | 1050 | 29500 | 868 | >1950 |
| | GM1810 | EPP1 | | | | | | | | |
| C. Ex. 6 | 100 parts | — | — | 64 | 41200 | 345 | 229 | 44800 | 889 | 467 |
| | Exceed 1023 | | | | | | | | | |
| C. Ex. 7 | 90 parts | — | 10 parts | 75 | 40700 | 200 | 142 | 43100 | 823 | 440 |
| | Exceed 1023 | | NA940000 | | | | | | | |
| C. Ex. 8 | 80 parts | — | 20 parts | 94 | 41500 | 101 | 134 | 40900 | 740 | 383 |
| | Exceed 1023 | | NA940000 | | | | | | | |
| Ex. 9 | 90 parts | 10 parts | — | 78 | 38300 | 326 | 407 | 40200 | 1153 | 980 |
| | Exceed 1023 | EPP1 | | | | | | | | |
| Ex. 10 | 80 parts | 20 parts | — | 98 | 33400 | 290 | 398 | 36200 | 1023 | 1070 |
| | Exceed 1023 | EPP1 | | | | | | | | |

We claim:

1. A polyolefin composition comprising a single-site linear low density polyethylene (mLLDPE) and an elastoplastic polypropylene present in an amount from 1 wt % to 30 wt % of the total composition.

2. The composition of claim 1, wherein the elastoplastic polypropylene comprises from 30 wt % to 90 wt % of a polyolefin elastomer and from 10 wt % to 60 wt % of a propylene homopolymer or propylene random copolymer.

3. The composition of claim 1, wherein the elastoplastic polypropylene has a flexural modulus less than 200 MPa (ISO 178/A), or a Shore D hardness (ISO 868) less than 40 points, or both.

4. The composition of claim 1, wherein the mLLDPE has a density within the range of 0.910 g/cm³ to 0.930 g/cm³.

5. The composition of claim 4, wherein the mLLDPE has a density within the range of 0.920 g/cm³to 0.930 g/cm³.

6. The composition of claim 2, wherein the propylene random copolymer comprises 85 wt % or more of propylene based on the random copolymer.

7. The composition of claim 6, wherein the propylene random copolymer comprises from 85 wt % to 99 wt % of propylene and from 1 wt % to 15 wt % of ethylene, 1-butene, or a mixture thereof.

8. The composition of claim 2, wherein the polyolefin elastomer is selected from ethylene-propylene based elastomers, ethylene-butene based elastomers, or mixtures thereof.

9. The composition of claim 2, wherein the elastoplastic polypropylene comprises from 65 wt % to 80 wt % of the polyolefin elastomer and from 20 wt % to 35 wt % of the propylene homopolymer or the propylene random copolymer.

10. The composition of claim 1, wherein the elastoplastic polypropylene comprises:
(a) from 10 wt % to 50 wt % of a homopolymer of propylene with isotactic index greater than 80, or a copolymer of propylene and a comonomer selected from the group consisting of ethylene, C₄—C₈ α-olefins, and mixtures thereof, which comprises greater than 85 wt % of propylene and has an isotactic index greater than 80;
(b) from 5 wt % to 20 wt % of a copolymer of ethylene and one or more C₃—C₈ α-olefins; and
(c) from 40 wt % to 80 wt % of a copolymer of ethylene and one or more C₃—C₈ α-olefins, which comprises from 20 wt % to 40 wt % of ethylene, is soluble in xylene at ambient temperature, and has an intrinsic viscosity from 1.5 to 5.5 dl/g.

11. A film comprising the composition of claim 1.

12. The film of claim 11, having a thickness greater than 1 mil, 1% secant machine-direction (MD) modulus greater than 35000 psi, MD tear strength greater than 1000 grams, and dart drop impact strength greater than 750 grams.

13. A method for improving the processability and physical property of mLLDPE, said method comprising blending the mLLDPE with from 5 wt % to 30 wt % of an elastoplastic polypropylene based on the blend.

14. The method of claim 13, wherein the mLLDPE has a density within the range of 0.910 g/cm³to 0.930 g/cm³.

15. The method of claim 14, wherein the mLLDPE has a density within the range of 0.920 g/cm³ to 0.930 g/cm³.

16. The method of claim 13, wherein the elastoplastic polypropylene comprises:
(a) from 10 wt % to 50 wt % of a homopolymer of propylene with isotactic index greater than 80, or a copolymer of propylene and a comonomer selected from the group consisting of ethylene, C₄—C₈ α-olefins, and mixtures thereof, which comprises greater than 85 wt % of propylene and has an isotactic index greater than 80;
(b) from 5 wt % to 20 wt % of a copolymer of ethylene and one or more C₃—C₈ α-olefins; and
(c) from 40 wt % to 80 wt % of a copolymer of ethylene and one or more C₃—C₈ α-olefins, which comprises from 20 wt % to 40 wt % of ethylene and is soluble in a xylene at ambient temperature, and has an intrinsic viscosity from 1.5 to 5.5 dl/g.
